(19) United States
(12) Patent Application Publication
(10) Pub. No.: US 2013/0103366 A1
(43) Pub. Date: Apr. 25, 2013

(54) PREDICTING CORROSION MECHANISMS FOR AN IRON-CONTAINING SURFACE IN CONTACT WITH A SOLUTION SATURATED IN AMMONIUM CHLORIDE

(71) Applicant: Christopher David Taylor, Los Alamos, NM (US)

(72) Inventor: Christopher David Taylor, Los Alamos, NM (US)

(73) Assignee: LOS ALAMOS NATIONAL SECURITY, LLC, Los Alamos, NM (US)

(21) Appl. No.: 13/279,842

(22) Filed: Oct. 24, 2011

(51) Int. Cl. G06F 7/60

(52) U.S. Cl. 703/2

(57) ABSTRACT

NH₄Cl precipitation can present deleterious effects on refinery surfaces when it combines with condensed water vapor to produce highly concentrated chloride and ammonia solutions. Density functional theory (“DFT”) methods were used to compute the adsorption energies for various species including NHₓ, OHₓ, Cl and H on the lowest energy iron-containing surface of a metallic component. The adsorption energies were combined with thermodynamic analysis to develop phase diagrams for the various species that may dominate the surface adsorption coverage. N, O, Cl, and H each possess regions of predominance on surface Pourbaix diagrams at 25° C. and 130° C. in the presence of a saturated NH₄Cl solution. N typically does not interfere with O adsorption and hence is unlikely to depassivate any protective oxide films. However, Cl can overlap regions of O surface stability to provide a competitive mechanism for hindering repassivation and/or accelerating the rate of metal dissolution.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to a process for predicting corrosion mechanisms for iron-containing surfaces of metallic components in contact with a solution that is saturated in ammonium chloride, and more particularly to predictions of surface electrochemistry of solutions saturated in ammonium chloride with Fe(110) from ab initio calculations.

### BACKGROUND OF THE INVENTION

Metallic components must withstand the chemical, temperature gradient, and pressurized environments to which they are constantly exposed [1]. Petroleum refining exposes metallic components to particularly aggressive chemicals, temperature gradients and high pressures. These conditions promote corrosion of these metallic components. A variety of corrosion mechanisms may be operating in these corrosive environments. “Sour water” in a petroleum stream may contain ammonia, amines, organic acids, chlorides, sulfides, hydrogen-sulfides, carbonates, and cyanides. Corrosion from the sour water may occur via corrosion mechanisms such as ammonium-chloride corrosion, ammonium bi-sulfide corrosion, high temperature sulfide corrosion, cyanide accelerated corrosion, and/or stress corrosion cracking that may be brought on by hydrogen, chloride, sulfide, or carbonate [2]. In addition, the various corrosion mechanisms and also their relative importance could change during the refining process [2].

The chemical, vapor pressure, flow, and temperature conditions in the vicinity of a metallic component are factors to consider when studying corrosion of the component. The thermodynamic and flow conditions of a process stream contribute to corrosion mechanisms for a component, or for a segment of a component, by eroding scales and changing the diffusion boundary layer of the electrolyte phase at the interface. For a given set of thermodynamic and flow conditions, the corrosion may occur via surface reactions at a protective or semi-protective scale on the metal, or at the exposed or partially-exposed surface of the metal.

Ammonium chloride (NH₄Cl) corrosion occurs in a process stream when conditions in the process stream allow ammonia and hydrogen chloride in the vapor phase to crystallize as hygroscopic NH₄Cl particles and allow the particles to interact with water to form saturated ammonium chloride solutions [1, 2]. Thermodynamic conditions for this mode of corrosion may be determined by considering the vapor pressures and phase-relations between the various gases.

In-situ techniques have been used to interrogate surface chemistry. Video scanning tunneling microscopy, for example, has been used to directly observe and measure the dissolution of Cu atoms at kink-sites on exposed Cu(111) terraces [3]. In-situ surface enhanced Raman spectroscopy has been used to detect the chemisorption of species on Cu and Ag surfaces under various conditions [4, 5].

Simulations have also been used to try to understand surface chemistry. Ab initio modeling, for example, has been used to study pre-passivation of metal surfaces by OH and O [6]. Ab initio modeling has also been used to probe the surface electrochemistry of hydrogen [7], the depassivation of nickel by chloride [8], and also to test proposed mechanisms for hydrogen embrittlement [9-11]. The ability to calculate reaction energies and barriers associated with surface chemistry allows a modeler to couple an understanding of surface phenomena with the boundary conditions imposed by the thermodynamic and flow conditions experienced by a metallic component of interest in order to gain a more complete understanding of the dominant mechanisms of corrosion for the metallic component.

To develop strategies for manipulating interactions between metallic components and their environment, the surface conditions are established for a particular set of pH, electrochemical potential, and ammonium chloride concentrations. Under a particular set of conditions, the stability of a passive oxide surface on iron may be determined, as well as whether a salt film exists on a surface, and whether there may be mechanisms that compete with corrosion mechanisms (chemisorption mechanisms, for example).

### SUMMARY OF THE INVENTION

In accordance with the purposes of the present invention, as embodied and broadly described herein, an aspect of the present invention includes a process for predicting corrosion mechanisms for corrosion of an iron containing surface in contact with a solution that is saturated in ammonium chloride (NH₄Cl). The process includes calculating adsorption energies for chemical species such as nitrogen-containing, oxygen-containing, chloride-containing, and hydrogen-containing species on the lowest energy surface presented by an iron-containing surface of a metallic component in the presence of a solution that includes NH₄Cl, in particular a solution that is saturated in NH₄Cl. Sour water is an example of such a solution, which may be saturated in NH₄Cl. The energies are calculated for at least two different temperatures, T1 and T2, wherein T1 is less than (i.e. <) T2. The calculated adsorption energies for the chemical species are used to construct plots of the Gibbs' free energy of adsorption versus the electrochemical potential for said chemical species at the temperature T1 and the temperature T2. The plots of the Gibbs' free energy of adsorption versus the electrochemical potential are used to construct surface Pourbaix diagrams for these chemical species, which include nitride, oxide, chloride, and hydrogen. A surface Pourbaix diagram is constructed for temperature T1 and a surface Pourbaix diagram is constructed for temperature T2. A saturated ammonium chloride solution is present for these surface Pourbaix diagrams. A surface Pourbaix diagram is a plot of electrochemical potential versus pH. The surface Pourbaix diagrams are used to determine regions of predominance for each of the chemical species, and the surface Pourbaix diagrams are used to predict a corrosion mechanism for the iron-containing surface of the metallic component. In an embodiment, the adsorption energies were calculated at a temperature T1 of 25° C., and also at a temperature of 130° C. The chemical species N, O, Cl, and H each possess regions of predominance on the phase diagram known in the art as a surface Pourbaix phase diagram at 25° C. and 130° C. under conditions where a saturated NH₄Cl solution is present. The surface Pourbaix phase diagram at 25° C. shows that chloride does not overlap with the oxide regions of the phase diagram, which suggests that repassivation will not be hindered by chloride adsorption, although acceleration of Fe dissolution in the active region may occur. The surface Pourbaix phase diagram at 130° C. shows that the region of predominance for Cl is much greater and diminishes that of O, which suggests that that Cl displacement of O on the iron-containing surface will hinder repassivation of exposed iron surfaces, thereby providing a mechanism for accelerated corrosion. Additionally, adsorption of Cl to the Fe surface in the immunity region may provide another means via which Cl-accelerated Fe corrosion may occur. It may be instructive to also consider the additional interaction of sulfides with the phase diagram.

### BRIEF DESCRIPTION OF THE DRAWINGS

FIG. 1a shows a side view of a slab model of a Fe(110) surface. FIG. 1b shows a top view of the surface with the high-symmetry sites considered for adsorption.

FIG. 2 shows several thermodynamic cycles that were used to calculate the free energy of adsorption of solution phase species to the metal surfaces shown in FIG. 1a and FIG. 1b.

FIG. 3 shows several plots of the Gibbs free energy of adsorption versus electrochemical potential under equilibrium conditions in the presence of a saturated ammonium chloride solution and ammonia at temperatures of 25° C. (i.e. 298 K) and 130° C. (i.e. 403 K).

FIG. 4 shows superposed surface and bulk Pourbaix diagrams at (a) 298 K and (b) 403 K under conditions of NH₄Cl saturation. Bulk Pourbaix diagrams were obtained from, or interpolated using, data from Beverskog and Puigdomenich [31].

### DETAILED DESCRIPTION

The invention relates to the predicting corrosion mechanisms for the corrosion of metallic components in the presence of solutions that include ammonium chloride. Sour water is an example of such a solution. Sour water may be saturated in ammonium chloride. These components may be made from mild steel, which is used in petroleum refining complexes. Mild steel has an amount of carbon in a range from 0.16% to 0.29%. The predominant element in mild steel targeted by corrosion reactions is iron. Fe(110) is the lowest energy surface presented by Fe in mild steel [12].

Ab initio modeling was used to examine the relative adsorption strengths of NHₓ, OHₓ, H, and Cl species on an exposed Fe (110) surface as a function of the local electrochemical potential.

Corrosion properties of mild steel may vary due to the presence of carbon and other impurities in the mild steel. Changes to the surface environment were considered as the thermodynamic boundary conditions were varied.

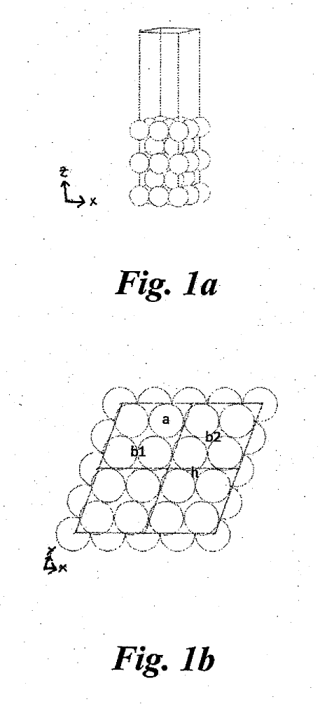

Surface-environment interactions were calculated using a ‘slab model’. In this model, a semi-infinite surface was modeled using several layers of metal atoms periodically extended in the x- and y-directions and separated by a vacuum layer (see FIG. 1). The properties of this metallic surface are then computed, and an appropriate number of metal layers are selected to provide satisfactory convergence of these properties. For Fe(110), it was shown previously that five layers were sufficient to represent bulk iron and its compact surfaces. Thus, five layers were used in the calculations. The spatial coordinates of the central layer (i.e. the third layer) were fixed. The height of the sub-surface layer (i.e. the second layer) above the third layer was fixed in a symmetric fashion. Then, the adsorption geometries and energies of a species on the surface were determined by creating a series of representative configurations and performing ab initio calculations. Although complex models of electrochemical interfaces have been used in the past, simpler models that neglect solvent have provided useful information about the surface chemistry [13].

Ab initio calculations were performed using the computer program VASP (VIENNA AB-INITIO SIMULATION PACKAGE) [14-16]. The electronic structure of the periodic atomic ensemble was expanded into a basis of plane-waves and the Brillouin zone was interpolated using a series of k-points. For the Fe(110) slab using a 2×2 periodic unit in the x-y direction, we found that a 7×7×1 k-point mesh following the Monkhorst-Pack scheme allows sufficient convergence of the electronic energy (<3 mev) [17]. This choice allows a coverage of 0.25 ML to be considered for the adsorbates. A cut-off of 500 eV was used for the plane-wave basis. The PW-91 functional was used to calculate the exchange-correlation energy [18], and projector-augmented wavefunctions were used to simulate the core electrons [19]. Thermal smearing using the Methfessel-Paxton scheme over 0.2 eV was used to accelerate convergence [20]. In order to compute the enthalpic, entropic, and zero-point contributions to the energy made by vibrational modes [21], harmonic frequencies were determined by performing finite-displacement calculations on the coordinates of the adsorbates in the optimized adsorption configurations. In these finite-displacement calculations, the geometry of the metal atoms was held fixed to avoid excessive calculation of terms that were expected to in large part cancel when final adsorption energies were determined. The Hessian was calculated by the method of central difference using displacements of ±0.015 Å. Zero-point energy contributions to the molecular reference states were made according to the experimental reference data made available in the “Computational Chemistry Comparison and Benchmarking Database” [22].

Once adsorption energies were calculated for the NHₓ, OHₓ, H and Cl species over the Fe(110) surface (the adsorption sites are shown in FIG. 1), thermodynamic quantities were computed from statistical mechanics and speciation considerations. For ammonium chloride corrosion, in an embodiment, a saturated NH₄Cl solution was considered to be in contact with the metal surface. The solubility of NH₄Cl for a range of temperatures may be obtained from the literature [23]. We considered the surface behavior at 25° C. (298K) and at 130° C. (403K) because 25° C. is the temperature at which most thermodynamic quantities are readily available, and 130° C. is roughly the maximum temperature seen by atmospheric overhead condensers in a refinery. It is important to know the

NH₄Cl(s)→(aq)equilibria

and the

NH₃/NH₄⁺equilibria

at these two temperatures. This was also taken from the literature [24].

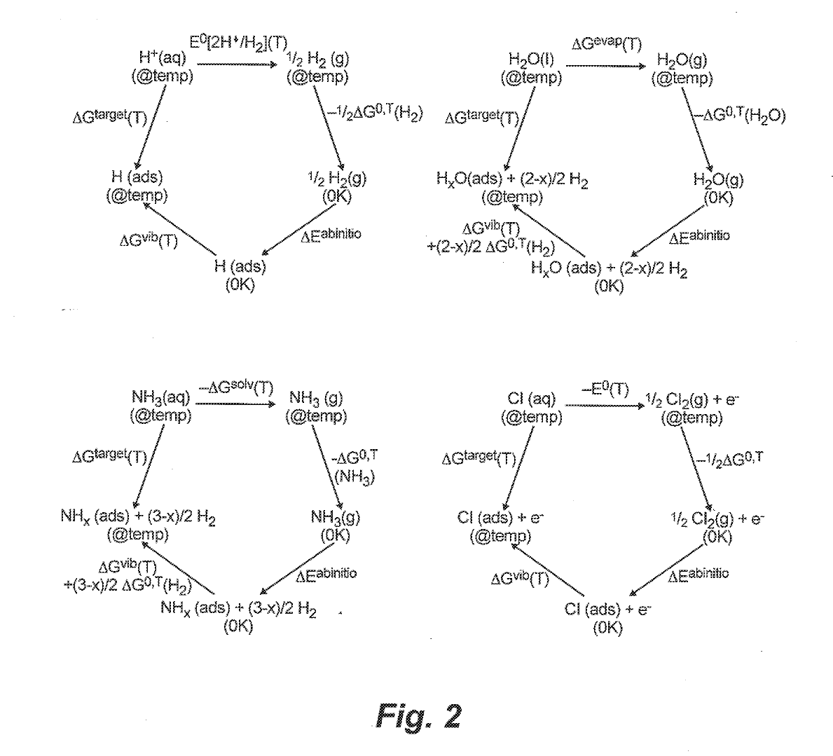

Adsorption energies are commonly determined in theoretical work by reference to a gaseous pre-adsorption state. Therefore, adsorption energies should be obtained from an appropriate set of thermodynamic cycles when constructing thermodynamic phase diagrams suitable for electrochemical conditions (see FIG. 2).

One should obtain from standard tables and the solvation literature the enthalpic and entropic contributions of the gas and solution phase pre-adsorption molecules of the adsorbed species, the solvation energies, and the electrochemical potentials for the Cl₂/2Cl⁻ and H₂|2H⁺ half-cell reactions [25-29]. The latter quantities at room temperature can be readily determined from the standard reduction potential tables [30]. At a temperature of 130° C., thermodynamic corrections are applied based on changes in solvation free energy of Cl⁻ and Fr, and the free energy changes for Cl₂ and H_{2 [}26-29].

In the course of applying these thermodynamic corrections to the ab initio data, it was assumed that the activity coefficients for all species are unity, i.e. concentration corrections to the Gibbs' free energies of a species X were made via the term

ΔG^{conc}(X)=RT ln [X].

Similar assumptions have been made previously in the construction of Pourbaix diagrams for iron [31]. However, this assumption is unlikely to be valid in some of the conditions encountered (for example, saturated NH₄Cl solutions can have concentrations of the order of 10 mol/L) [23].

Once the thermodynamic corrections were made based upon the standard reduction potentials, solvation data, etc. the free energy was plotted as a function of the electrochemical potential by taking into account the number of electrons being consumed or released as a result of the particular adsorption process being considered [13] These reactions include the following:

H⁺(aq)+e⁻→H(ads);

Cl⁻(aq)→Cl(ads)+e⁻;

NH₃(aq)→NHₓ(ads)+(3−x)H⁺(aq)+(3−x)e⁻; and

H₂O(l)→OHₓ(ads)+(2−x)H⁺(aq)+(2−x)e⁻.

The adsorption energies for all high symmetry adsorption states and zero-point energy corrections for the preferred adsorption states, are given in TABLES 1 and 2. TABLE 1 summarizes ab-initio adsorption energies for various oxygen-containing, nitrogen-containing, chloride-containing, and hydrogen-containing species, including H, NHₓ, OHₓ, and Cl species on Fe(110) prior to zero-point energy correction, given in eV. Reference states are the bare Fe(110) surface and (a) H₂ for H, (b) Cl₂ for Cl, (c) NH₃ for NHₓ with H₂ energies used for hydrogen balance, (d) H₂O for OHₓ with H₂ energies used for hydrogen balance. ATOP, BRIDGE 1, BRIDGE 2, and HOLLOW are the various sites on the Fe(110) surface with the species bind to the surface. Preferred (i.e. lowest energy) sites are highlighted in bold and underlined.

TABLE 1

| Species | ATOP | BRIDGE1 | BRIDGE2 | HOLLOW |
|---|---|---|---|---|
| H | 0.037 | −0.51 | 0.677 | −0.685 |
| Cl | −2.316 | −2.618 | −0.089 | −2.811 |
| NH₃ | −0.733 | −0.508 | −0.347 | 2.012 |
| NH₂ | −0.081 | −0.658 | −0.686 | 1.659 |
| NH | 0.905 | −0.38 | −1.005 | −0.945 |
| N | | 0.802 | −0.487 | −0.32 |
| H₂O | −0.383 | −0.245 | −0.078 | 0.916 |
| OH | −0.266 | 0.889 | −1.004 | −0.426 |
| O | 0.564 | −0.541 | −1.042 | −1.058 |

TABLE 2 below summarizes zero-point energy (ZPE) corrections for the adsorbate using ab initio calculation for adsorbates on Fe(110).

TABLE 2

| Adsorbate | ZPE, eV |
|---|---|
| NH₃ | 1.03 |
| NH₂ | 0.66 |
| NH | 0.38 |
| N | 0.07 |
| OH₂ | 0.67 |
| OH | 0.37 |
| O | 0.07 |
| H | 0.17 |
| Cl | 0.03 |

The results for each of the different adsorbate groups are described in the sections that follow. Phase diagrams are also presented using various thermodynamic assumptions.

Adsorption Geometries and Energies for OHₓ.

The preferred adsorption geometry for H₂O is atop, in which position the oxygen atom is directly over a Fe atom, with an O—Fe distance of 2.30 Å. The O—H bond length is 0.98 Å, with the O—H bonds oriented parallel to the surface. The adsorption energy for H₂O is −0.38 eV relative to the bare Fe(110) surface and an isolated molecule of H₂O.

When a hydrogen atom is removed from H₂O, the binding geometry changes to the bridge-2 site (see FIG. 1), which is the longer bridge site on the Fe(110) surface. The oxygen atom sits between the two Fe atoms forming the long bridge, and the O—Fe bond length is 1.98 Å. The O—H bond is oriented perpendicular to the surface, thus giving the oxygen atom a trigonal planar type bonding configuration. The O—H bond length is slightly longer than in the adsorbed H₂O, 0.99 Å. The binding energy of OH relative to H₂O and half the H₂ molecular energy is −1.00 eV at this preferred site.

The binding of O to the surface is favored at the three-fold hollow site, where O is bound to three Fe atoms, with Fe—O bond lengths of 1.87, 1.88 and 1.90 Å. The height of the O atom above the surface plane is 1.09 Å. The binding energy of O at this preferred site relative to a H₂O initial state and a generated H₂ molecule to accommodate the missing H atoms is −1.06 eV.

For OHₓ therefore we find a progression towards increasing oxygen coordination to the Fe(110) surface as the hydrogen atoms are removed, with increasing binding energy from H₂O to OH, but only a marginal increase from OH to O. Based on internal energy arguments alone, and neglecting electrochemical effects, one would therefore predict that water would adsorb to Fe(110) and then dissociate to produce adsorbed O bound to the Fe(110) surface and releasing a hydrogen molecule to the environment. A full thermodynamic treatment relevant to process conditions will be described later.

Adsorption Geometries and Energies for NHₓ.

Like H₂O, NH₃ binds to the surface at the atop site. The Fe—N bond length is somewhat shorter than the Fe—O bond length in the H₂O case, being 2.13 Å compared to 2.30 Å, respectively. The N—H bond lengths are 1.02, 1.02 and 1.03 Å, and the N—H bonds are directed away from the surface, giving the N molecule a tetrahedral bonding configuration. The binding energy relative to an isolated NH₃ molecule and the bare Fe(110) surface is −0.73 eV, stronger than the Fe(110)-OH₂ interaction.

Removal of a hydrogen atom from NH₃ prompts relocation of the adsorbed molecule to a higher coordination site, as in H₂O. The NH₂ adsorbate binds at the bridge-2 site, similarly to OH. The N—H bonds point away from the surface, giving the N a tetrahedral bonding configuration. The N—H bond lengths are slightly longer than in the adsorbed NH₃ molecule, being 1.03 and 1.04 Å. The Fe—N bond lengths are shorter than in the NH₃ case, being 2.01 Å compared to 2.13 Å, respectively. The binding energy measured relative to an isolated parent NH₃ molecule, using half the energy of H₂ to maintain the hydrogen balance is −0.69 eV.

Removal of the second H atom from NH₃ does not lead to further coordination of the N atom to the surface, but, as in OH, the N atom now adopts a trigonal configuration with two bonds to the Fe(110) surface at the bridge-2 site, and a third bond to the H atom, oriented perpendicular to the surface. The Fe—N bond-lengths are 1.87 Å, and the N—H bond lengths are 1.04 Å each. The binding energy relative to NH₃ and using the energy of H₂ to maintain the hydrogen balance is −1.01 eV.

The adsorption of N also occurs at the bridge-2 site, however, the N atom is so close to the surface plane (it is elevated only 0.68 Å compared to 1.09 Å for O) that it also forms long bonds with the two next-nearest neighbor Fe atoms also. There are therefore four Fe—N bonds: two short bonds across the bridge-2 sites with a length of 1.78 Å and two long Fe—N bonds of 2.00 Å. The binding energy of N to the surface relative to the NH₃ molecule and the bare Fe(110) surface is −0.49 eV, again using H₂ to balance the hydrogen count.

As in H₂O, therefore, we find that the molecular state NH₃ is bonded to the surface preferentially at the atop site, and that dehydrogenating the molecule causes the adsorption bond to change to a higher coordination. The dehydrogenated forms all bind at the bridge-2 site, and ultimately N is so closely bound to the surface that one can consider it to form four bonds with the surface Fe atoms: two close and two short bonds. Based on internal energy arguments, and excluding electrochemical effects, the preferred adsorption state for NH₃ on Fe(110) appears to be the chemisorbed NH state.

Adsorption Geometries and Energies for Cl.

The adsorption of atomic Cl takes place at the three-fold hollow site with Fe—Cl distances of 2.40, 2.40 and 2.24 Å. The binding energy is −2.81 eV relative to the bare Fe(110) surface and the isolated Cl₂ molecule, indicating a strong tendency for Cl₂ to dissociate over the Fe(110) surface, based on internal energy arguments alone.

Adsorption Geometries and Energies for H.

Hydrogen preferentially binds at the three-fold hollow site on the Fe(110) surface. The three bonds formed to the nearest Fe atoms have lengths 1.75, 1.75 and 1.81 Å. The hydrogen binding energy relative to ½ H₂ and the bare Fe(110) surface is −0.69 eV.

Electrochemical Phase Diagrams for NHₓ, OHₓ, Cl and H over Fe(110) at 25° C. and 130° C.

The Gibbs' free energies of NHₓ, OHₓ, Cl and H adsorption states over Fe(110) were determined for the temperatures of 25° C. and 130° C. using thermodynamic assumptions described below.

Thermodynamic Corrections to Ab Initio Absorption Energies

### H(ads)/ft Free Energy.

Following the thermodynamic cycle in FIG. 2, the target free energy for the adsorption of hydrogen to the surface from ionic hydrogen, i.e. for the reaction

H⁺(aq)+e⁻→H(ads)

in solution is given by the equation

ΔG^{target}(T)=eE^{0[}2H⁺/H₂](T)− 1/2ΔG^{0,T}(H₂)+ΔE^{abinitio}+ΔG^{vib}(T)−kT ln [H⁺]+eU

with terms defined as follows: e is the charge on an electron, E^{0[}2H⁺/H₂](T) is 0 at all temperatures when referencing the electrochemical potential, U, to the standard hydrogen electrode as we are doing here. ½ ΔG^{0,T}(H₂) can be determined from the integrated heat capacity of H₂, as obtained by combining the 298 K data from CCCBDB and the NIST WebBooks. ΔE^{abinitio} is the adsorption energy obtained from the density functional theory computations, including the zero point energy corrections for molecular H₂, and the adsorbed H state. ΔG^{vib}(T) is obtained from the enthalpic and entropic contributions made by the vibrational modes obtained from the surface density functional theory calculations. The kTln [H⁺] term adjusts the free energy based upon the pH, as determined from the NH₄⁺/NH₃ equilibrium and/or assumptions of pH control. The final term adjusts the reaction energy based upon the electrochemical potential. The values for ½ ΔG^{0,T}(H₂), ΔE^{abinitio}, ΔG^{vib}(T) are provided in Table 3 below. In Table 3, when values need to be provided for two separate temperatures 298K and 403K, the higher temperature value is given in parentheses. Also in Table 3, superscript (1) is in units of eV while superscript (2) is in units of V SHE).

TABLE 3

| Species | ΔG^{solv/evap}(T)⁽¹⁾ | E^{0 (2)} | ΔG^{0, T (1)} | ΔE^{abinitio (1)} | ΔG^{vib}(T) ⁽¹⁾ |
|---|---|---|---|---|---|
| H | | 0 (0) V | | −0.66 | −0.00 |
| | | | | | (−0.00) |
| Cl | | −1.36 | | −2.80 | −0.07 |
| | | (−0.82) V | | | (−0.12) |
| NH₃ | −0.19 | | | −0.60 | −0.05 |
| | (−0.13) eV | | | | (−0.10) |
| NH₂ | | | | −0.79 | −0.04 |
| | | | | | (−0.07) |
| NH | | | | −1.25 | −0.03 |
| | | | | | (−0.06) |
| N | | | | −0.91 | −0.02 |
| | | | | | (−0.04) |
| H₂O | −0.09 | | | −0.27 | −0.05 |
| | (+0.03) eV | | | | (−0.10) |
| OH | | | | −1.05 | −0.02 |
| | | | | | (−0.05) |
| O | | | | −1.28 | −0.01 |
| | | | | | (−0.03) |

Cl(ads)/C⁻ Free Energy.

Following the thermodynamic cycle in FIG. 2, the target free energy for the adsorption of chlorine to the surface from chloride, i.e. for the reaction Cl⁻(aq) Cl(ads)+e⁻ in solution is given by the equation

ΔG^{target}(T)=−eE⁰[Cl₂2/Cl⁻](T)− 1/2ΔG^{0,T}(Cl₂)+ΔE^{abinitio}+ΔG^{vib}(T)−kT ln [Cl⁻]−eU.

E⁰[Cl₂/2Cl⁻](T) is −1.36 V at 298 K. At 403 K the potential needs to be adjusted based not only upon changes in the relative free energies of Cl₂ and Cl⁻, but also in the shift associated with changes in the free energy of the H₂/2H⁺ half-cell reaction. Shifts in the half-cell reactions are determined by incorporating the free energy changes in Cl₂ and H₂ between 298 K and 403 K using the thermodynamic data compiled in the NIST WebBook, and for Cl− and H+ using the equation ΔG=ΔH−TΔS to compute the change in free energies due to temperature with solvation. In the latter term, only the standard (298 K) quantities for ΔH and ΔS are available, and thus there is some assumption made here. Beverskog and Puigdomench indicate that these assumptions are probably sound up to 150° C. ½ ΔG^{0,T}(Cl₂) can be determined from the integrated heat capacity of Cl₂, as obtained by combining the 298 K data from CCCBDB and the NIST WebBooks. ΔE^{abinitio} is the adsorption energy obtained from the density functional theory computations, as described above for hydrogen. ΔG^{vib}(T) is obtained from the enthalpic and entropic contributions made by the vibrational modes obtained from the surface density functional theory calculations. The kTln [Cl⁻] term adjusts the free energy based upon the chloride concentrations, as determined from the NH₄Cl solubility product data in ref [23]. The final term adjusts the reaction energy based upon the electrochemical potential. The values for ΔG^{0,T}(Cl₂), ΔE^{abinitio}, ΔG^{vib}(T) and eE⁰[Cl₂/2Cl⁻](T) are provided in Table 3.

NHₓ(ads)/NH₃ Free Energy.

Following the thermodynamic cycle in FIG. 2, the target free energy for the adsorption of NHₓ to the surface from NH₃, i.e. for the reaction NH₃(aq)→NHₓ(ads)+(3−x)H⁺+(3−x)e⁻ in solution is given by the equation

ΔG^{target}(T)=−ΔG^{solv}(T)− 1/2ΔG^{0,T}(NH₃)+ΔE^{abinitio}+ΔG^{vib}(T)+(3−x)/2ΔG^{0,T}(H₂)−kT ln [NH₃]+(3−x)kT ln [H⁺]−(3−x)eU

Since the H₂/H⁺ half-cell is defined to be 0 V through use of the SHE reference convention, the cycle shown in FIG. 2 for NIL is isoenergic to that producing H⁺ rather than H₂. ΔG^{solv}(T) is the solvation energy for NH₃(g) going into aqueous solution, and is determined by applying the tabulated values of ΔH^{o} and ΔS^{o} given by Marcus to the Gibbs' free energy equation ΔG=ΔH−TΔS. ΔG^{0,T}(NH₃) can be determined from the integrated heat capacity of NH₃, as obtained by combining the 298 K data from CCCBDB and the NIST WebBooks. ΔE^{abinitio} is the adsorption energy obtained from the density functional theory computations, as described above for hydrogen. ΔG^{vib}(T) is obtained from the enthalpic and entropic contributions made by the vibrational modes obtained from the surface density functional theory calculations. ΔG^{0,T}(H₂) is calculated as described above for hydrogen. The kTln [H⁺] and kTln [NH₃] terms adjust the overall reaction free energy based upon the pH and ammonia concentrations, as determined from the NH₄Cl solubility product data, the NH₄⁺/NH₃ equilibria and any pH assumptions. The final term adjusts the reaction energy based upon the electrochemical potential. The values for ΔG^{solv} (T), ΔG^{0,T}(NH₃), ΔE^{abinitio}, and ΔG^{vib}(T) are provided in TABLE 3 for each of the NHₓ species.

OHₓ(ads)/OH₂ Free Energy.

Following the thermodynamic cycle in FIG. 2, the target free energy for the adsorption of OHₓ to the surface from H₂O, i.e. for the reaction H₂O(aq)→OHₓ(ads)+(2−x)H⁺+(2−x)e⁻ in solution is given by the equation

ΔG^{target}(T)=ΔG^{evap}(T)− 1/2ΔG^{0,T}(H₂O)+ΔE^{abinitio}+ΔG^{vib}(T)+(3−x)/2ΔG^{0,T}(H₂)+(2−x)kT ln [H⁺]−(2−x)eU.

Since the H₂/H⁺ half-cell is defined to be 0 V through use of the SHE reference, the cycle shown in FIG. 2 for OHₓ is equivalent to that producing H⁺ rather than H₂.

The various terms closely parallel those for NHₓ above, with the exception that ΔG^{solv}(1) in the case of NH₃(g) is replaced by ΔG^{evap} the Gibbs' free energy of evaporation of H₂O. Also, the term kTln [NH₃] has no analog, as we are assuming the activity of water does not change, although of course in highly concentrated solutions this assumption may not be sound. The values for ΔG^{evap}(T), ΔG^{0,T}(H₂O), ΔE^{abinitio}, and ΔG^{vib}(T) are provided in TABLE 3 for each of the OHₓ species.

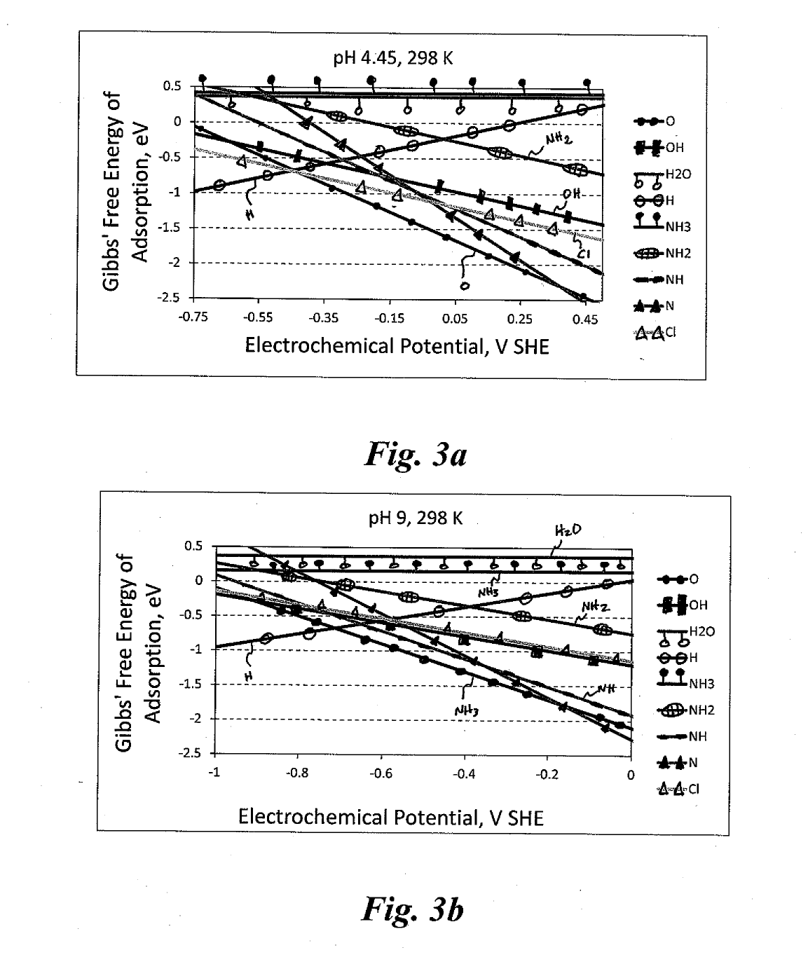

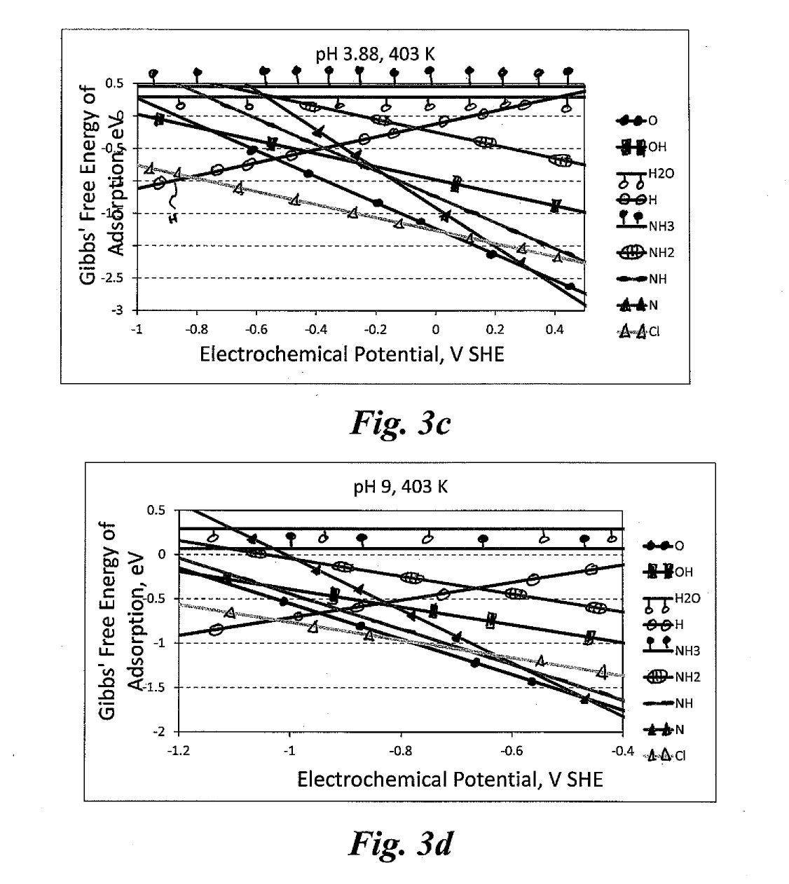

Two sets of conditions were applied at each temperature: an alkaline pH of 9.0 was applied in one case, and in the second case, the pH was set to the equilibrium pH associated with the saturated concentration of NH₄Cl in otherwise pure water (via the NH₃/NH₄+ equilibrium). At 25° C. this latter condition leads to a pH of 4.45 units and at 130° C. the corresponding pH is 3.88 units. As a point of reference, neutral pH at 130° C. is 5.85. At 25° C. the lower pH condition leads to NH₃ and Cl⁻ concentrations of 3.5×10⁻⁵ M and 7.4 M, respectively. At the higher pH condition and 25° C., the NH₃ and Cl⁻ concentrations are 0.93 M and 7.4 M, respectively. At 130° C. the lower pH condition leads to NH₃ and Cl⁻ concentrations of 1.3×10⁻⁴ M and 15.7 M, respectively. At the higher pH condition and 25° C., the NH₄⁺ and Cl⁻ concentrations are 8.24 M and 15.7 M, respectively. The Gibbs' free energy was then plotted as a function of the electrochemical potential (vide supra) (see also FIG. 3). When NH_{X} or OHₓ species are adsorbed, we consider any excess hydrogen atoms from the parent molecule (NH₃ or H₂O, respectively) to be released into solution, i.e. for the NH state we plot the Gibbs' free energy for the reaction:

NH₃(aq)→NH(ads)+2H⁺(aq)+2e⁻

and similarly for the remaining NHₓ and OHₓ species.

Adsorption reactions that do not exchange electrons with the surface appear as horizontal lines on the diagrams in FIG. 3, whereas adsorption reactions that do exchange electrons with the surface have a non-zero slope, equal to the number of electrons exchanged. Reduction reactions have a positive slope. Oxidation reactions have a negative slope. The intersection of the lines shows where two states are in equilibrium. The lowest energy state at each given potential will correspond to the state that dominates the exposed Fe(110) surface at that potential. The results of such inspections shall now be discussed.

Surface Chemistry at 298 K.

At 298 K three surface phases are predominant on the Fe(110) surface: H, O, and N. In the pH moderated “sour water” conditions, where the pH is controlled to 9.0, the hydrogenated surface is stable at potentials below −710 mV SHE, and the hydrogen evolution reaction is likely to proceed. Between −710 and −170 mV SHE the surface is covered by a pre-passive/passive oxygen layer. Beyond −170 mV SHE the oxygen layer is displaced by a nitrogen layer, which is also likely to have protective effects. If pH moderating species are not present, and the NH₄Cl equilibrium is allowed to establish the pH to the more acidic, equilibrium value of 4.45, the same general phases apply, yet between −450 and −420 mV SHE there is a window of preferred thermodynamic stability for a chloride phase. In this window, chloride may be active in accelerating the corrosion of the mild steel. The phase transitions are shifted to more anodic potentials at this pH also. The H phase is stable up to −450 mV SHE (Standard Hydrogen Electrode), the chloride phase is stable between −450 and −420 mV SHE, and the O phase between −420 mV SHE up to +370 mV SHE. The N phase dominates beyond 370 mV SHE. The broader window for O stability is due to the favoring of the OH dissociation to form O at more alkaline conditions, and the converse disfavoring of H adsorption under the same conditions.

Surface Chemistry at 403 K.

When the temperature is elevated to 403 K the chloride phase becomes significantly more important. This change in behavior is mostly due to the relative shift in the Cl₂/Cl— reduction half-cell reaction compared to the H₂/H₊ reaction, thus enhancing the tendency to electrochemically adsorb chloride, while raising the energy for reactions that produce H⁺.

Under free pH conditions, in which ammonium dissociation determines the acidity, (pH 3.88) the hydrogen covered surface dominates up to −820 mV SHE, at which point Cl becomes the dominant surface species. At 40 mV SHE the stability of the adsorbed O phase then displaces Cl, which in turn is displaced by N at 320 mV SHE. There is therefore a significant potential range at this pH which would allow for Cl to activate the surface with resulting dissolution behavior expected.

Under alkaline pH, where the pH has been increased through measures such as the introduction of excess NH₃ in solution, the general pattern remains but with differences in detail. The H/Cl transition occurs at −1020 mV SHE, and the Cl/O transition at −790 mV SHE. At −470 mV SHE the O/N transition takes place. Ultimately this leads to an expansion in the oxygen stabilized region, and a contraction of the chloride zone. Due to the higher pH, the alkaline-favored products of OHₓ and NHₓ dissociation: O(ads) and N(ads) are stabilized at lower electrochemical potentials.

Comparison with Solid-State Pourbaix Diagrams.

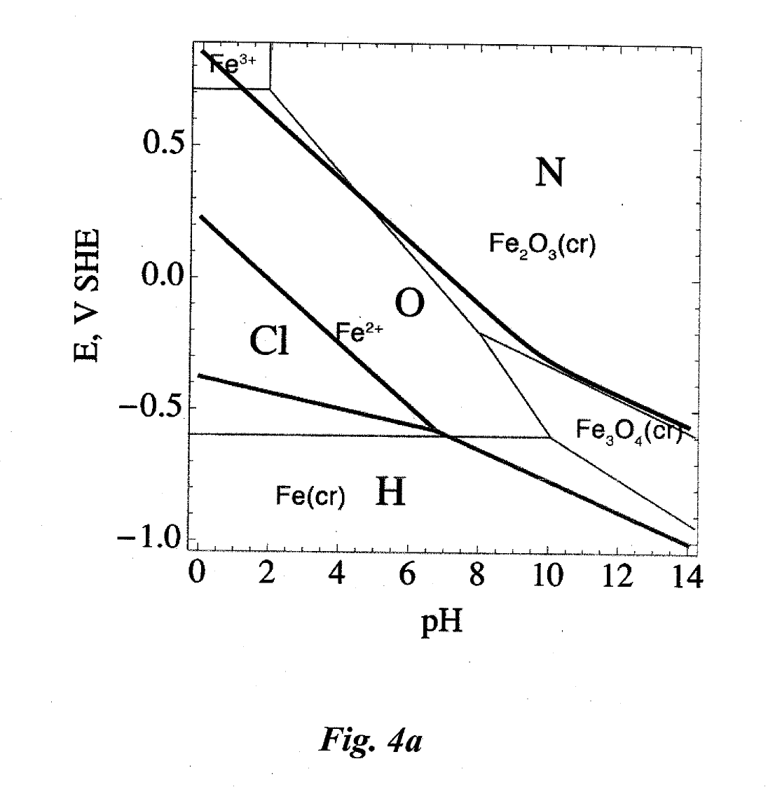

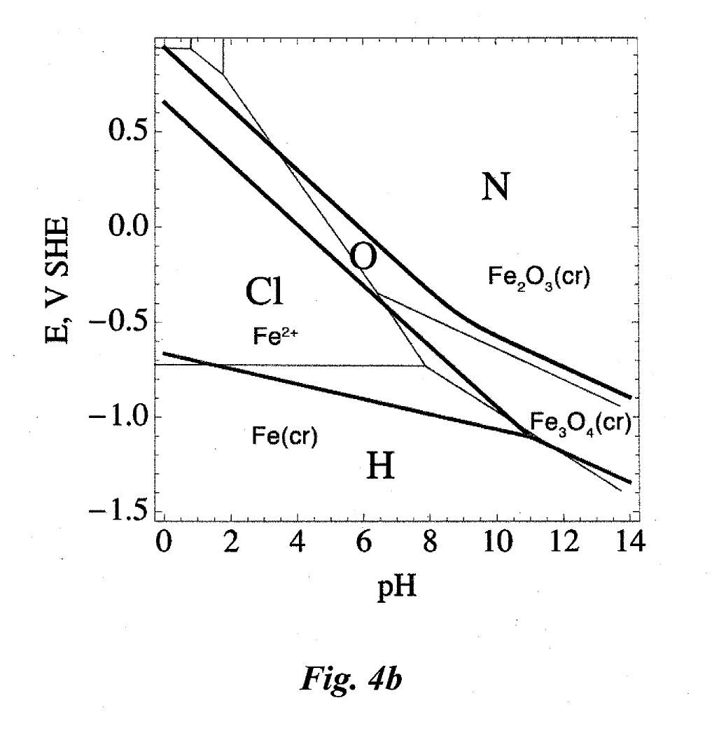

The aforementioned results only apply to the thermodynamics applicable to the exposed Fe(110) surface. Such a surface may be present in the immunity region of the Fe Pourbaix diagram, or during surface-exposing events, such as film cracking or localized film dissolution. By creating maps such as in FIG. 3 at various potentials, or solving for the equilibrium potentials between phases at various given pH values arithmetically, one can construct the equivalent of a Pourbaix pH-E diagram for the Fe(110) surface based on the ab initio data presented herein. Such diagrams are presented for the temperatures of 298 K and 403 K in FIGS. 4 (a) and (b), respectively, with the solid-state Pourbaix diagrams overlaid in gray [31]. By examining these diagrams, we can see at which potential-pH regions chloride may interfere with the immunity and passive regions of the Pourbaix diagram for iron, and therefore may lead to uniform or localized corrosion effects.

At 298 K the Cl adsorption on Fe(110) only occurs during the active corrosion region, in which region O and H may also adsorb depending on pH and potential. The passive regions are marked by O adsorption to any exposed surfaces that may be present, indicating that healing can occur rapidly. In the Fe₂O₃(cr) region of the solid-state Pourbaix diagram, N adsorption is also possible, which has been indicated elsewhere to have passivating effects. Considering this diagram, therefore, saturated NH₄Cl solutions interacting with Fe at room temperature would appear to have no deleterious effects other than a likely acceleration of the dissolution of iron to Fe²⁺ in some portions of the active corrosion region.

At 403 K, on the other hand, there is significant overlap of the Cl adsorption phase with portions of the immunity Fe(cr) phase and the passive Fe₃O₄(cr) phase in the regions of sour-water (alkaline) pH. In the latter case, chloride competition with oxygen for surface sites during events that expose bare metallic surface could prevent repassivation from occurring and lead to localized corrosion. In situ observations by Marcus on Cu(111) and Ni(111) indicated that OH and O adsorption phases appeared to be precursors to passive film formation [32, 33]. Competition for sites via chloride adsorption, as demonstrated in the present work, would, therefore, hinder passivation. Similarly, adsorption of chloride to the Fe(110) surface in the immunity region could lead to the complexation and dissolution of surface metal atoms at kink sites or edges, as demonstrated to occur for Cu through video in situ STM work by Magnussen [3]. At 403 K the stability range of O is narrower than at 298 K, primarily due to a shifting of the O/Cl boundary whereas the behavior of the N/O boundary is much the same.

In summary, ab initio computation of adsorption energies for various NHₓ, OHₓ, Cl and H species on the lowest energy surface presented by iron indicate that N, O, Cl, and H each possess regions of predominance on the surface Pourbaix diagram at 25° C. and 130° C. under conditions where a saturated NH₄Cl solution is present. At 25° C. chloride does not overlap with the oxide regions of the phase diagram, suggesting that repassivation will not be hindered by chloride adsorption, although acceleration of Fe dissolution in the active region may occur. At 130° C. the region of predominance for Cl is much greater, and diminishes that of O, indicating that Cl displacement of O on the Fe surface will hinder repassivation of exposed Fe surfaces, thereby providing one mechanism for accelerated corrosion. Additionally, adsorption of Cl to the Fe surface in the immunity region may provide another means via which Cl-accelerated Fe corrosion may occur. It may be instructive to consider the additional interaction of sulfides with the generated phase diagram.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### REFERENCES

The following references are incorporated by reference herein.
1. White, “Materials Selection for Petroleum Refineries and Gathering Facilities,” 1998, Houston Tex.: NACE International.
2. “Damage Mechanisms Affecting Fixed Equipment in the Refining Industry, 2003, Washington D.C.: American Petroleum Institute.
3. Magnussen et al., “In-Situ Video STM Studies of Dynamic Processes at Electrochemical Interfaces,” Faraday Discuss., 2002, vol. 121, pp. 43-52.
4. Niaura, “Surface-enhanced Raman Spectroscopic Observation of Two Kinds of Adsorbed OH— Ions at Copper Electrode,” Electrochim. Acta, 2000, vol. 45, pp. 3507-3519.
5. Niaura et al., “Surface Enhanced Raman Spectroscopy of Phosphate Anions: Adsorption on Silver, Gold, and Copper Electrodes,” J. Phys. Chem. B., 1997, vol. 101, pp. 9250-9262.
6. Taylor et al., “First-Principles Prediction of Equilibrium Potentials for Water Activation by a Series of Metals,” J. Electrochem. Soc., 2007, vol. 154, no. 12, pp. F217-F221.
7. Taylor et al., Theoretical Analysis of the Nature of Hydrogen on the Electrochemical Interface between Water and a Ni(111) Single-Crystal Electrode,” J. Electrochem. Soc., 2007, vol. 154, no. 3, pp. F55-F64.
8. Pineau et al., “Density Functional Theory Study of the Interaction of Cl— with Passivated Nickel Surfaces,” Electrochem. Solid-State Lett., 2003, vol. 6, no. 11, pp. B47-B51.
9. Lu et al., “Hydrogen-Enhanced Local Plasticity in Aluminum: An ab initio Study,” Phys. Rev. Lett., 2001, vol. 87, pp. 95501-95504.
10. Lu et al., “Energetics of Hydrogen Impurities in Aluminum and their Effect on Mechanical Properties,” Phys. Rev. B., 2002, vol. 65, pp. 64102-64109.
11. Lu et al., “Hydrogen Embrittlement of Aluminum: The Crucial Role of Vacancies,” Phys. Rev. Lett., vol. 94, pp. 155501-155504.
12. Blonski et al., “Structural Electronic and Magnetic Properties of bee Iron Surfaces,” Surf. Sci., 2007, vol. 601, no. 1, pp. 123-133.
13. Rossmeisl et al., “Calculated Phase Diagrams for the Electrochemical Oxidation and Reduction of Water over Pt(111),” J. Phys. Chem. B., 2006, vol. 110, pp. 21833.
14. Kreese et al., “Ab Initio Molecular Dynamics for Liquid Metals,” Phys. Rev. B., 1993, vol. 47, pp. 558-561.
15. Kreese et al., “Efficient Iterative Schemes for Ab Initio Total-Energy Calculations Using a Plane-Wave Basis Set,” Phys. Rev. B., 1996, vol. 54, no. 16, pp. 11169-11186.
16. Kreese et al., “Efficiency of Ab Initio Total Energy Calculations for Metals and Semiconductors Using a Plane-Wave Basis Set,” Comput. Mater. Sci., 1996, vol. 6, pp. 15-50.
17. Monkhorst et al., “Special Points for Brillouin-Zone Integrations,” Phys. Rev. B., 1976, vol. 13, pp. 5188-5192.
18. Perdew et al., “Atoms, Molecules, Solids, and Surfaces: Applications of the Generalized Gradient Approximation for Exchange and Correlation,” Phys. Rev. B., 1992, vol. 46, pp. 6671-6687.
19. Kreese et al., “From Ultrasoft Pseudopotentials to the Projector Augmented Wave Method,” Phys. Rev. B., 1000, vol. 59, no. 3, pp. 1758-1775.
20. Methfessel et al., “High-Precision Sampling for Brillouin-Zone Integration in Metals,” 1989, vol. 40, pp. 3616-3621.
21. Atkins, “Physical Chemistry,” 6^{th} Edition, 1998, Oxford: Oxford University Press, p. 485, 925-927, and 942.
22. Johnson III, ed., “NIST Computational Chemistry Comparison and Benchmark Database, NIST Standard Reference Database Number 101, Release 14 Sep. 2006,” (retrieved Sep. 2, 2009).
23. Cohen-Adad et al. eds., “Alkali Metal and Ammonium Chlorides in Water and Heavy Water (binary systems),” Solubility Data Series, ed. J. W. Lorimer, vol. 47, 1991, International Union of Pure and Applied Chemistry: Oxford.
24. Mesmer et al., “Thermodynamics of Aqueous Association and Ionization Reactions at High Temperatures and Pressures,” J. Sol. Chem., 1988, vol. 17, no. 8, pp. 699-718.
25. Ben-Naim et al., “Solvation Thermodynamics of Nonionic Solutes,” J. Chem. Phys., 1984, vol. 81, no. 4, pp. 2016-2027.
26. Marcus, “The Hydration Entropies of Ions and Their Effects on the Structure of Water,” J. Chem. Soc. Faraday Trans., 1986, vol. 82, pp. 233-242.
27. Marcus, “Thermodynamics of Salvation of Ions,” J. Chem. Soc. Faraday Trans., 1987, vol. 83, pp. 2995-2999.
28. Marcus, “The Thermodynamics of Salvation of Ions. Part 2.—The Enthalpy of Hydration at 298.15 K,” J. Chem. Soc. Faraday Trans., 1987, vol. 83, pp. 339-349.
29. Linstrom et al. eds., “NIST Chemistry WebBook, NIST Standard Reference Database Number 69,” retrieved Sep. 21, 2009, National Institute of Standards and Technology: Gaithersburg Md., 20899.
30. Bard et al., “Standard Potentials in Aqueous Solutions,” 1985, New York, USA: IUPAC (Marcel Dekker).
31. Beverskog and Puigdomenech, “Revised Pourbaix Diagrams for Iron at 25-300 C,” Coor. Sci., 1996, vol. 38, no. 12, pp. 2121-2135.
32. Seyeux et al., “In Situ Scanning Tunneling Microscopic Study of the Initial Stages of Growth and of the Structure of the Passive Film on Ni(111) in 1 mM NaOH(aq),” J. Solid State Electrochem., 2005, vol. 9, no. 5, pp. 337-346.
33. Maurice et al., “In Situ STM Study of the Initial Stages of Oxidation of Cu(111) in Aqueous Solution,” Surf. Sci., 2000, vol. 458, pp. 185-194.

What is claimed is:

1. A process for predicting a corrosion mechanism for an iron-containing surface of a metallic component in contact with a solution that is saturated in ammonium chloride, comprising:
calculating adsorption energies for chemical species comprising nitrogen-containing, oxygen-containing, chloride-containing, and hydrogen-containing species on an iron-containing surface of a metallic component in the presence of a solution that is saturated in NH₄Cl,
using the adsorption energies for said chemical species to construct plots of the Gibbs' free energy of adsorption versus the electrochemical potential for said chemical species at a temperature T1 and a temperature T2 wherein T1<T2,
using the plots of the Gibbs' free energy of adsorption versus the electrochemical potential to construct a surface Pourbaix diagram for said chemical species at said temperature T1 and a surface Pourbaix diagram for said chemical species at said temperature T2t, a surface Pourbaix diagram comprising a plot of electrochemical potential versus pH, and
using the Pourbaix diagrams to predict a corrosion mechanism for the iron-containing surface of the metallic component.

2. The process of claim 1, wherein T1 is about 25° C. and T2 is about 130° C.

3. The process of claim 1, wherein regions in the Pourbaix diagrams are determined in which chloride does not overlap with oxide regions of the diagram, which would suggest that repassivation will not be hindered by chloride absorption.

4. The process of claim 1, wherein regions in the Pourbaix diagrams are determined, said regions comprising a region comprising a predominance for chloride and diminished oxide, which if present would suggest that chloride displacement by oxide in the iron-containing surface would hinder repassivation of exposed iron-containing surfaces.

5. The process of claim 1, wherein the saturated solution comprises sour water.

6. The process of claim 1, wherein the iron-containing surface comprises a low energy surface.
